(19) United States
(12) Patent Application Publication
(10) Pub. No.: US 2008/0226351 A1
(43) Pub. Date: Sep. 18, 2008

(54) Toner Paddle for Distributing Toner Within An Image Forming Device

(76) Inventors: Jedediah Taylor Dawson, Lexington, KY (US); Jarrett C. Gayne, Lexington, KY (US); Asmund Vego, Lexington, KY (US)

Correspondence Address: John J. McArdle, Jr.;Lexmark International, Inc., Intellectual Property Department, 740 West New Circle Road, Lexington, KY, 40550, US

(21) Appl. No.: 11/686,658

(22) Filed: Mar. 15, 2007

(51) Int. Cl. G03G 15/08

(52) U.S. Cl. 399/254

(57) ABSTRACT

The present application is directed to devices for moving toner within an image forming device. In one embodiment, the device includes a reservoir with an inlet that leads into the reservoir through a first sidewall. New toner may be introduced through the inlet and into the reservoir. A paddle may be positioned within the reservoir to move the toner from the inlet and through the reservoir. The paddle may prevent the toner from accumulating at the inlet which may act as a block to prevent further toner from being moved into the reservoir. The paddle may include a shaft with a weighted first arm extending from the shaft in a first direction and a second arm extending from the shaft in a second direction. The arms are weighted such that the first arm is heavier than the second arm. The paddle is positioned within the reservoir such that rotation of the paddle moves the toner from the inlet throughout the reservoir.

### BACKGROUND

The present application is directed to devices and methods for moving toner and, more specifically, to a weighted toner paddle for distributing toner within a reservoir of an image forming device.

Image forming devices including copiers, laser printers, facsimile machines, and the like, include a photoconductive member that receives toner during the image formation process. The toner is stored in a reservoir adjacent to the drum and is transferred to the drum's photoconductive surface through a nip point between a nip blade and developer roller. The toner image is then transferred directly or indirectly through an intermediate member to a media sheet, such as a blank sheet of paper. The media sheet is then heated thereby permanently fusing the toner to the sheet.

Toner cartridges may be replaceable to allow a user to input new toner into the image forming device after a first amount of toner originally within the device has been depleted. The toner cartridges are positioned within the image forming device at locations that provide convenient access to a user. The image forming device includes mechanisms for moving the newly-introduced toner from the new cartridge to the photoconductive drum.

The image forming device and toner cartridges should be designed to produce an overall product having the smallest possible dimensions. This may be a key selling point to consumers who desire the small dimensions because the devices are easier to manipulate and move, and occupy a minimal amount of space in a workstation where available space if often at a premium.

### SUMMARY

The present application is directed to devices for moving toner within an image forming device. In one embodiment, the device includes a reservoir with an inlet that leads into the reservoir through a first sidewall. New toner may be introduced through the inlet and into the reservoir. A paddle, may be positioned within the reservoir to move the toner from the inlet and through the reservoir. The paddle may prevent the toner from accumulating at the inlet which may act as a block to prevent further toner from being moved into the reservoir. The paddle may include a shaft with a weighted first arm extending from the shaft in a first direction and a second arm extending from the shaft in a second direction. The arms are weighted such that the first arm is heavier than the second arm. The paddle is positioned within the reservoir such that rotation of the paddle moves the toner from the inlet throughout the reservoir.

### BRIEF DESCRIPTION OF THE DRAWINGS

FIG. 1 is a schematic side view of an image forming device according to one embodiment.

FIG. 2 is a schematic side view of a developer unit and a photoconductive unit according to one embodiment.

FIG. 3 is a perspective view of a toner cartridge according to one embodiment.

FIG. 4A is a rear perspective view of an imaging unit comprising four imaging stations according to one embodiment.

FIG. 4B is a front perspective view of an imaging unit comprising four imaging stations according to one embodiment.

FIG. 5 is a perspective cutaway view of a developer unit according to one embodiment.

FIG. 5A is a schematic side view of a paddle according to one embodiment.

FIG. 5B is a schematic side view of a paddle according to one embodiment.

FIG. 6 is a schematic side view of a developer unit according to one embodiment.

FIG. 7 is a perspective view of a developer unit according to one embodiment.

FIG. 8 is a perspective view of a developer unit with the cam removed according to one embodiment.

### DETAILED DESCRIPTION

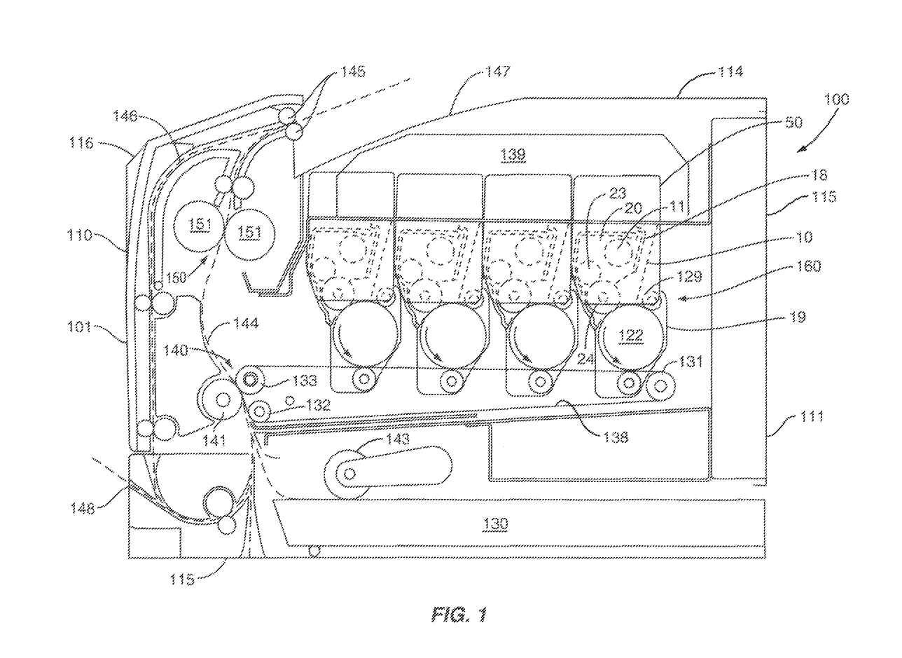

The present application is directed to toner paddle positioned to move toner within a reservoir. The reservoir includes an inlet for receiving new toner. The toner paddle includes a weighted arm and is positioned to move the toner from the inlet and throughout the reservoir FIG. 1 illustrates one embodiment of an image forming device 100. The device 100 includes a media input tray 130 positioned in a lower section of a body 101. The tray 130 is sized to contain a stack of media sheets that will receive color and/or monochrome images. The media input tray 130 is preferably removable for refilling. A control panel 116 may be located on the front 110 of the body 101. Using the control panel 116, the user is able to enter commands and generally control the operation of the image-forming device 100. For example, the user may enter commands to switch modes (e.g., color mode, monochrome mode), view the number of images printed, take the device 100 on/off line to perform periodic maintenance, and the like.

A first toner transfer area 160 includes an imaging unit with one or more imaging stations 10. The imaging stations 10 are aligned horizontally extending from the front 110 to the back 111 of the body 101. Each imaging station 10 includes a developer unit 18, a photoconductor unit 19, and a toner cartridge 50. Each of the imaging units 10 is mounted such that photoconductive (PC) drums 122 are substantially parallel. For purposes of clarity, the units 18, 19, and cartridge 50 are labeled on only one of the imaging stations 10. In one embodiment, each of the imaging stations 10 is substantially the same except for the color of toner.

The developer unit 18 includes a toner reservoir 20 to contain the toner, a toner adder roll 23, and a developer roll 24, A paddle 11 is positioned within the reservoir 20 to move the toner. The photoconductor unit 19 includes a charging roll 129 and a PC drum 122.

The charging roll 129 forms a nip with the PC drum 122, and charges the surface of the PC drum 122 to a specified voltage such as −1000 volts, for example. A laser beam from a printhead 139 is directed to the surface of the PC drum 122 and discharges those areas it contacts to form a latent image. In one embodiment, areas on the PC drum 122 illuminated by the laser beam are discharged to approximately 300 volts. The developer roll 24, which also forms a nip with the PC drum 122, then transfers toner to the PC drum 122 to form a toner image. The toner is attracted to the areas of the PC drum 122 surface discharged by the laser beam from the printhead 139.

An intermediate transfer mechanism (ITM) 138 is disposed adjacent to each of the imaging stations 10. In this embodiment, the ITM 138 is formed as an endless belt trained about support roll 131, tension roll 132 and back-up roll 133. During image forming operations, the ITM 138 moves past the imaging stations 110 in a clockwise direction as viewed in FIG. 1. One or more of the PC drums 122 apply toner images in their respective colors to the ITM 138. In one embodiment, a positive voltage field attracts the toner image from the PC drums 122 to the surface of the moving ITM 138.

The ITM 138 rotates and collects the one or more toner images from the imaging stations 10 and then conveys the toner images to a media sheet at a second transfer area. The second transfer area includes a second transfer nip 140 formed between the back-up roll 133 and a second transfer roll 141.

A media path 144 extends through the device 100 for moving the media sheets through the imaging process. Media sheets are initially stored in the input tray 130 or introduced into the body 101 through a manual feed 148. The sheets in the input tray 130 are picked by a pick mechanism 143 and moved into the media path 144, In this embodiment, the pick mechanism 143 includes a roll positioned at the end of a pivoting arm. The roll rotates to move the media sheets from input tray 130 towards the second transfer area. In one embodiment, the pick mechanism 143 is positioned in proximity (i.e., less than a length of a media sheet) to the second transfer area with the pick mechanism 143 moving the media sheets directly from the input tray 130 into the second transfer nip 140. For sheets entering through the manual feed 148, one or more rolls are positioned to move the sheet into the second transfer nip 140.

The media sheet receives the toner image from the ITM 138 as it moves through the second transfer nip 140. The media sheets with toner images are then moved along the media path 144 and into a fuser area 150. Fuser area 150 includes fusing rolls or belts 151 that form a nip to adhere the toner image to the media sheet. The fused media sheets then pass through exit rolls 145 that are located downstream from the fuser area 150. Exit rolls 145 may be rotated in either forward or reverse directions. In a forward direction the exit rolls 145 move the media sheet from the media path 144 to an output area 147. In a reverse direction, the exit rolls 145 move the media sheet into a duplex path 146 for image formation on a second side of the media sheet.

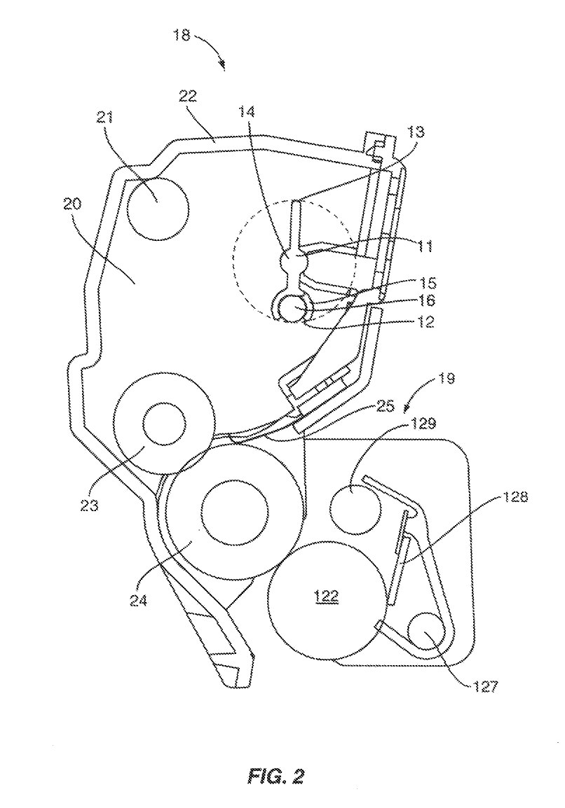

FIG. 2 illustrates a sectional view of the developer unit 18 and the photoconductive unit 19. The developer unit 18 includes an inlet 21 that leads into the toner reservoir 20. A paddle 11 is positioned within the reservoir 20 to agitate and move the toner. Paddle 11 is rotatably positioned within the reservoir 20 and includes a weighted arm 12 and a second arm 13 that each extend outward on opposite sides of a shaft 14. The toner adder roll 23 is positioned to direct the toner towards the developer roll 24. The photoconductive unit 19 includes the PC drum 122 and the charge roll 129. A blade 128 may be positioned against the PC drum 122 to remove residual toner that is not transferred to the ITM belt 138. The residual toner falls into a housing and is moved by an auger 127 laterally through and out of the photoconductive unit 19.

In one embodiment, the developer unit 18 and the photoconductive unit 19 are separate members that are connected together as a single unit. One or more springs (not illustrated) may be positioned to maintain the developer roll 24 of the developer unit 18 in contact with the PC drum 122 in the photoconductor unit 19.

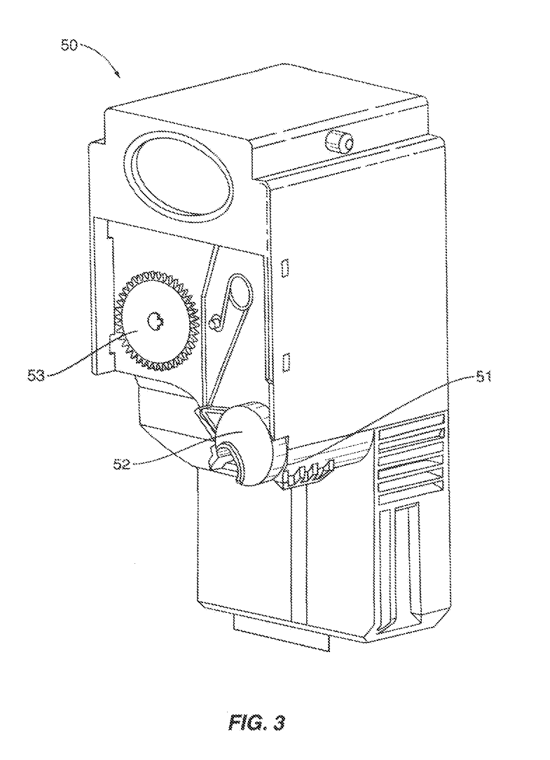

In one embodiment as illustrated in FIG. 3, toner is introduced through the inlet 21 from a toner cartridge 50. The toner cartridge 50 includes an enclosed interior sized to hold a quantity of toner. The toner cartridge 50 includes an outlet 51 with a movable shutter 52. The shutter 52 is movable between a closed orientation to prevent toner from moving from the interior and an open orientation to allow the toner to move from the interior and into the developer unit 18. A gear 53 is positioned on the exterior of the toner cartridge 50. Gear 53 is operatively connected to an auger within the interior that moves the toner through the outlet 51. One embodiment of a toner cartridge is disclosed in U.S. patent application Ser. No. 11/556,863 entitled “Shutter for a Toner Cartridge for Use with an Image Forming Device that was filed on Nov. 6, 2006, which is herein incorporated by reference.

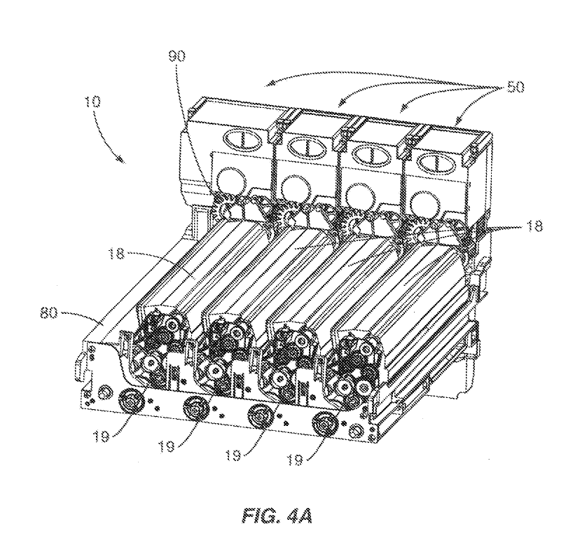

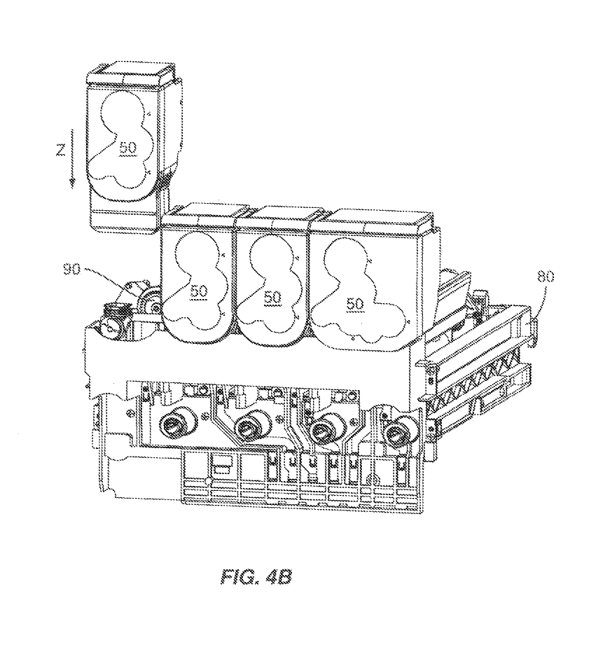

The imaging unit 10 that includes one or more developer units 18 photoconductor units 19, and toner cartridges 50 may be positioned within a frame 80 within the body 101 of the image forming device 100 as illustrated in FIGS. 4A and 4B. When the toner cartridges 50 are attached to the frame 80, the shutter 52 on the cartridges 50 moves from the closed orientation to the open orientation. The toner is then moved from the cartridges 50 and through the inlets 21 and into the reservoirs 20 of the developer units 8. The toner cartridges 50 are removably attached to the frame 80 such that they can be replaced when the toner is depleted. In one embodiment, the toner cartridges 50 are inserted in a vertical direction Z and mount to the top of the frame 80. The body 101 of the image forming device 100 may include a door along a top side to provide access for removal and insertion of the toner cartridges 50.

The toner introduced into the developer unit 18 should be distributed through the reservoir 20. The distribution is further complicated because the inlet 21 may be positioned at an end of the reservoir 20. Further, the developer units 18 are positioned within the body 101 of the image forming device 100 with the reservoir 20 being substantially level. Therefore, gravity cannot be used to move the toner from the inlet 21 and laterally throughout the reservoir 20. The paddle 11 functions to move the toner laterally along the length of the reservoir 20.

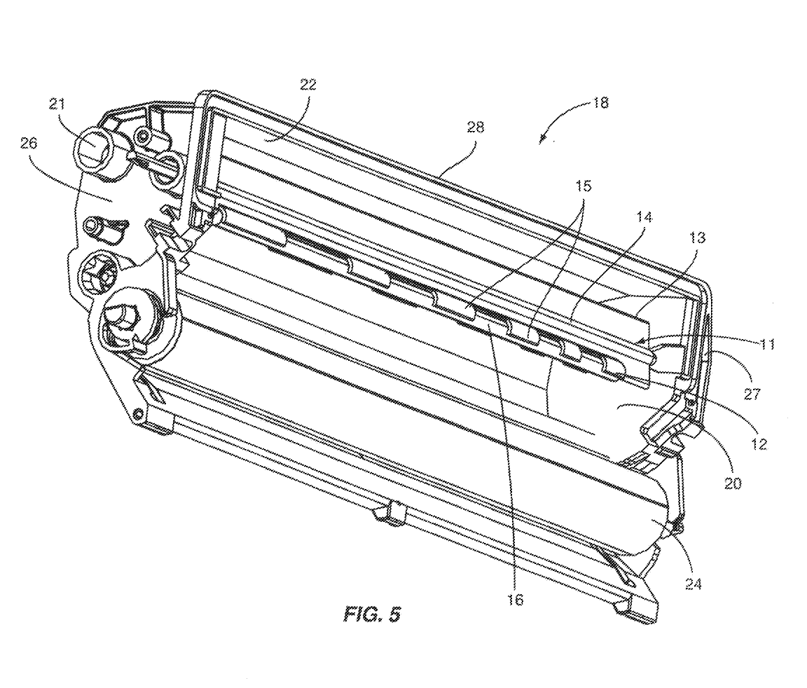

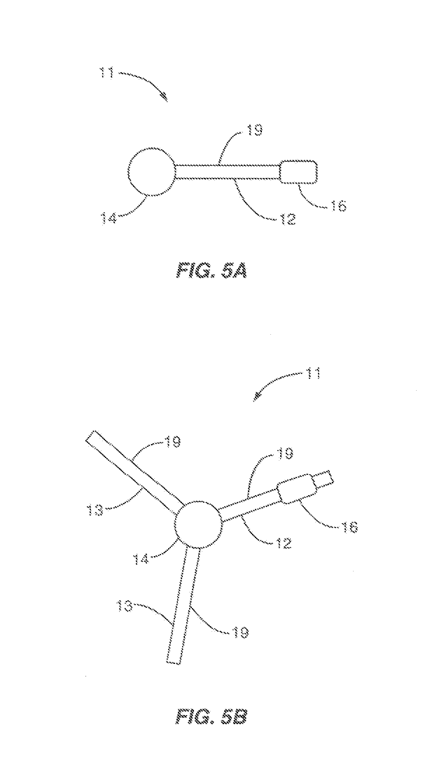

FIG. 5 illustrates the paddle 111 positioned within the reservoir 20 and extending between a first sidewall 26 and a second sidewall 27 of the developer unit 18. For purposes of clarity, a top wall of the developer unit 18 has been removed to allow viewing of the interior of the reservoir 20. In one embodiment, the reservoir 20 includes an elongated shape with a length extending between the sidewalls 26, 27 being greater than a width extending between a third sidewall 28 and the developer roll 24. In one embodiment, the paddle 11 extends completely across the length and is attached to the first and second sidewalls 26, 27. In another embodiment, the paddle 11 is attached only to the first sidewall 26.

Paddle 11 includes at least one weighted arm 12 that extends outward from a shaft 14. FIG. 5A illustrates an embodiment with the paddle 11 including a single arm. In one embodiment, the arms include a fin section 19 that extends outward from the shaft 14 and terminates at an end. A weight 16 is positioned along the fin section 19 a distance from the shaft 14. The weight 16 may be positioned at the end of the fin section 19 opposite from the shaft 14 as illustrated in FIG. 5A, or the weight 16 may be positioned inward from the end as illustrated in FIG. 5B. Paddle 11 may include one or more arms. Embodiments include a single arm 12 as illustrated in FIG. 5A, a pair of arms 12, 13 as illustrated in FIG. 5, and more than two arms 12, 13 as illustrated in FIG. 5B.

In the embodiment of FIG. 5, the paddle 11 includes a first weighted arm 12 and a second arm 13 that extend outward from opposite sides of a shaft 14. In one embodiment, the weighted arm 12 includes fingers 15 that wrap around a weight 16. The fingers 15 may include a plurality of discrete sections that are spaced apart along the length of the shaft 14 as illustrated in FIG. 5. In another embodiment, fingers 15 are continuous and extend along an extended length of the shaft 14. The shaft 14 may be centered along the paddle 11 with a distance, between the center of the shaft 14 to the end of the weighted arm 12 being substantially equal to a distance from the center of the shaft 14 to the end of the second arm 13.

The weighted arm 12 is heavier than the second arm 13 thus allowing the paddle to free-all during a rotation as will be explained below. The weight difference between the arms 12, 13 may vary depending upon the application.

As illustrated in FIG. 2 a rotational envelope of the paddle 11 is spaced laterally away from the inlet 21 to prevent the paddle 11 from blocking the introduction of toner into the reservoir 20. The paddle 11 does not contact the toner until it accumulates within the reservoir 20 to the height of the envelope.

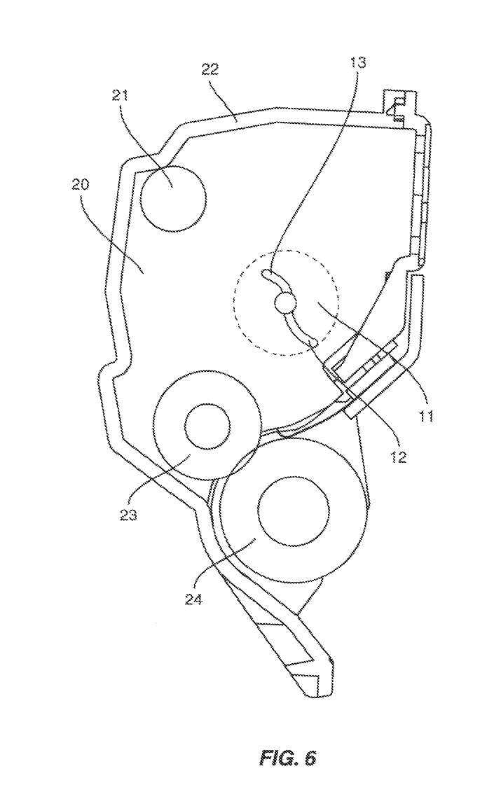

FIG. 6 illustrates another embodiment with the paddle 11 positioned to move the toner. Paddle 11 is positioned at a lower position within the reservoir 20 and in closer proximity to the developer roll 24. In this embodiment, the weighted arm 12 is longer than the second arm 13. Further, both arms of the paddle 11 are curved.

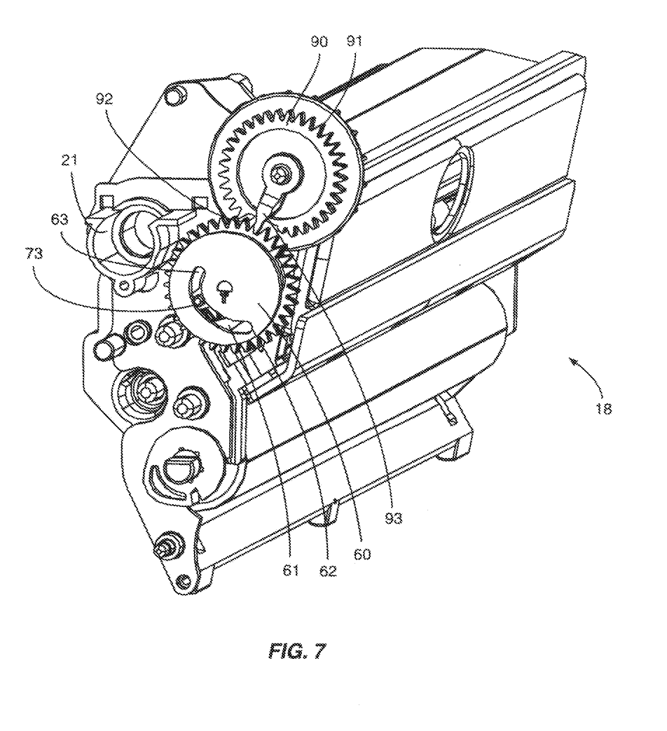

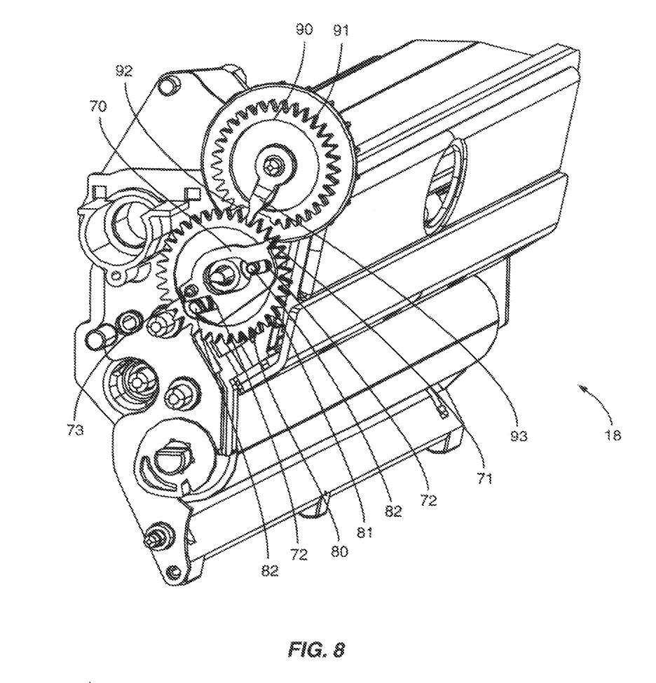

In addition to moving the toner within the reservoir 20, paddle 11 may also function as a toner sensor, FIGS. 7 and 8 illustrate one embodiment of the gear and cam arrangement operatively connected to the paddle 11 to sense an amount of toner within the reservoir 20, The developer unit 18 includes a drive gear 80 and a second gear 90. Drive gear 80 includes a plurality of teeth 81 extending around the perimeter, and at least one post 82 extending outward from the face. The second gear 90 includes a plurality of teeth 91 extending around the perimeter with a toothless section 92 extending along a section of the perimeter. Second gear 90 further includes a leg 93 attached to the face. Leg 93 extends outward beyond the perimeter of the second gear 90 and overlaps over the drive gear 80.

As illustrated in FIG. 7, a cam 60 is attached and centered on the face of the drive gear 80. Cam 60 includes a cam profile 61 with a first end 61 and a second end 63. The first end 62 is positioned radially outward in proximity to the perimeter of the cam 60. The second end 63 is positioned radially inward from the first end 62 and in closer proximity to a centerpoint of the cam 60.

FIG. 8 illustrates the toner sensor with the cam 60 removed from the drive gear 80 for clarity. As illustrated in FIG. 8, the posts 82 extend outward from the face of the drive gear 80 towards the cam 60 for mounting a pawl 70. The pawl 70 may be mounted between the drive gear 80 and the cam 60; however, other locations are acceptable for positioning the pawl. The pawl 70 includes two elongated openings 72 to receive the posts 82 and allow the pawl 70 to slide relative to the cam 60. A boss 73 extends outward from the pawl 70 and is positioned within the cam profile 61 as illustrated in FIG. 7.

When the developer unit 18 is mounted within the image forming device 10, the drive gear 80 is driven by a gear (not illustrated) attached to the developer unit 18. The paddle 11 and cam 60 are connected together to rotate at the same speed and orientation. Both are freely rotated by the drive gear 80 defined as providing a rotational force for moving the paddle 11 and cam 60 from a toner contact point to a release point at an upper portion of the paddle envelope. However, both the paddle 11 and cam 60 may rotate at a faster speed during an angular displacement portion of the revolution from the release point to the toner contact point due to the offset weighting of the paddle 11. By way of example, when the paddle 11 positioned at an upper position within the revolution, the offset weighting of the paddle 1 provides for the paddle 11 and cam 60 to freely rotate ahead or fall forward of the drive gear 80 until the paddle 11, and specifically the weighted arm 12, contacts the toner within the reservoir 20. At the point of contact with the toner both the cam 60 and the paddle 11 will lie substantially motionless until the drive gear 80 rotates to the position, or “catches up”. At this points the continuously rotating drive gear 80 will provide a force to rotate the paddle 11 and cam 60 through the remainder of the envelope.

In one embodiment, the release point is at the top-dead-enter point of the envelope; however, other release positions on the revolution may also be used for determining the angular rotation of the paddle 11. As the drive gear 80 catches up” to the cam mechanism 60, the pawl 70 is reset to the initial position. This process is continued for each revolution of the paddle 11 and cam 60.

The drive gear 80 continuously rotates due to the intermeshing of the teeth 81 with a corresponding gear within the body 101 of the image forming device 100. This rotation pushes the paddle 11 and cam 60 through continuous revolutions with the paddle 11 and cam 60 falling in front of the rotation of the drive gear 80 until the weighted arm 12 of the paddle 11 contacts the toner within the reservoir 20. Once the paddle 1 stops falling, the drive gear 80 catches up to the paddle 11 and cam 60 and rotates through the complete revolution. As the cam 60 rotates ahead of the drive gear 80, the cam profile 61 pushes the pawl boss 73 radially inward. This movement results in the elongated openings 72 sliding along the posts 82 and pawl extension 71 moving radially outward from the center of the pawl. The larger the angular displacement of the paddle 11, from the release point to the toner contact point, the further the cam 60 and cam profile 61 pushes pawl extension 71 radially outward. The movement of the pawl 70 is dictated by the dimensions of the cam profile 61. In one embodiment, the pawl 70 begins to radially move outward upon any angular displacement of the paddle 11 ahead of the drive gear 80. At an angular displacement of about 120 degrees relative to release, point, the pawl displacement is maximized. In other embodiments, the amount of movement of the pawl 70 and degree of angular displacement can be adjusted depending upon the specific parameters of the image forming device.

Upon a predetermined amount of lateral movement, the pawl 70 eventually contacts the leg 93 of the second gear 90. The pawl 70 is within the same plane as the leg 93 to provide for contact upon a predetermined amount of pawl movement. The second gear 90 is positioned relative to the drive gear 80 such that the toothless section 92 on the perimeter is aligned with the drive gear 80. Prior to contact between the pawl 70 and leg 93, rotation of the drive gear 80 does not translate to the second gear 90 because the toothless section 92 does not provide for the teeth 81, 91 of the two gears to intermesh and the leg 93 is positioned above the edge of the drive gear teeth 81.

When an adequate amount of toner is within the reservoir 20, the amount of angular displacement of the paddle 11 results in a minimal amount of radial movement of the pawl 70. Thus, there is no contact when the pawl extension 71 rotates past the leg 93. As images are printed, the amount of toner passed from the reservoir to the PC drum 122 reduces the toner level. Eventually, the toner level will decrease to a level causing the paddle 11 to have an angular displacement ahead of the drive gear 80 an adequate amount resulting in the pawl extension 71 contacting the leg 93.

As the pawl extension 71 contacts the leg 93, the pawl 70 transfers rotation to the second gear 90 and rotates the second gear 90 and amount for the drive gear teeth 81 to mesh with the second gear teeth 91. This results because the drive gear 80 and the second gear 90 are positioned within the same plane. The continuous rotation of the drive gear 80 result in one complete rotation of the second gear 90 until the toothless section 92 is again positioned adjacent to the drive gear teeth 81 and the process is repeated.

The developer unit 18 is positioned within the body 101 of the image forming device 100 for the second gear 90 to mesh with gear 63 on the toner cartridge 50 (see FIG. 3). Rotation of the second gear 90 translates to rotation of gear 53 which moves toner through the outlet 51 of the cartridge 50 and into the inlet 21 to re-supply the reservoir 20.

This process of continual replenishment of toner within the reservoir 20 continues until all the toner within the cartridge 50 is extinguished. At that point, additional toner level sensors may be mounted within the cartridge 50 to indicate to a user that a new cartridge is required. One example of a toner sensor system is disclosed in U.S. Pat. No. 6,510,291 herein incorporated by reference. Terms such as “first”, “second”, and the like, are also used to describe various elements, regions, sections, etc and are also not intended to be limiting. The terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A device to move toner within an image forming device comprising:
a reservoir;
an inlet leading into the reservoir through a first sidewall;
a paddle positioned within the reservoir and including a shaft with a weighted first arm extending from the shaft in a first direction and a second arm extending from the shaft in a second directions the first arm including a greater weight than the second arm, the paddle extending outward from the first sidewall;
rotation of the paddle within the reservoir moves the toner from the inlet and throughout the reservoir.

2. The device of claim 1, wherein the shaft extends across a length of the reservoir and is attached to the first sidewall and an opposite second sidewall.

3. The device of claim 1, wherein a rotational envelope of the paddle is positioned vertically below the inlet.

4. The device of claim 1, wherein a rotational envelope of the paddle is spaced laterally away from the inlet.

5. The device of claim 1, wherein the first and second arms are each substantially straight.

6. The device of claim 1, further including a gear mechanism operatively connected to the shaft to rotate the paddle in a first direction, the gear mechanism adapted for the weighted first arm to free fall from a first rotational orientation downward until contacting the toner within the reservoir.

7. The device of claim 6, wherein the gear mechanism is adapted to rotate the paddle in the first direction from a second rotational orientation contacting the toner to the first rotational orientation.

8. A device to move toner within an image forming device comprising:
a reservoir for holding the toner and including a first sidewall and an opposite second sidewall;
an inlet leading into the reservoir through the first sidewall;
a paddle positioned within the reservoir and including a shaft that extends between the first sidewall and the second sidewall, the paddle including an arm that extends outward from the shaft and a weight positioned on the arm and spaced away from the shaft;
a gear mechanism operatively connected to the shaft to rotate the paddle in a first direction, the gear mechanism adapted for the arm to free fall from a first rotational orientation downward until contacting the toner within the reservoir and to thereafter drive the paddle back to the first rotational orientation;
rotation of the paddle within the reservoir moves the toner from the inlet and towards the second sidewall.

9. The device of claim 8, wherein the arm is adapted to free fall from a top-dead-center position through an arc of up to about 120 degrees.

10. The device of claim 8, wherein the paddle further includes a second arm that extends outward from the shaft, the second arm being positioned on an opposite side of the shaft from the arm, the arm including a greater weight than the second arm.

11. The device of claim 8, wherein the paddle includes a length to extend between the first and second sidewalls.

12. The device of claim 8, further including a developer roll positioned within the reservoir.

13. The device of claim 8, wherein a paddle envelope is spaced laterally away from the inlet.

14. The device of claim 8, wherein the reservoir includes an elongated shape with a length extending between the first and second sidewalls being greater than a width.

15. A device to move toner within an image forming device comprising:
a reservoir for holding the toner and including a first sidewall and an opposite second sidewall;
an inlet leading into the reservoir through the first sidewall;
a paddle positioned within the reservoir and including a shaft that extends between the first sidewall and the second sidewall, the paddle including a first arm that extends outward from the shaft in a first direction and a second arm that extends outward from the shaft in a second direction, the first arm including a greater weight than the second arm;
a gear mechanism operatively connected to the shaft to rotate the paddle in a first direction, the gear mechanism adapted for the paddle to freely move from a first rotational orientation with the first arm in a top-dead-center orientation to a second orientation where the first arm contacts the toner;
rotation of the paddle within the reservoir moves the toner from the inlet and towards the second sidewall.

16. The device of claim 15, wherein the gear mechanism is further adapted to drive the paddle in the first direction from the second orientation back to the top-dead-center orientation.

17. The device of claim 15, wherein the reservoir includes an elongated shape with a length defined between the first and second sidewalls and a width defined between a third sidewall and a developer roll, the length being greater than the width.

18. The device of claim 15, wherein a rotational envelope of the paddle is positioned laterally away from the inlet.

19. The device of claim 15, further including a developer roll and a photoconductor roll positioned within the reservoir.

20. The device of claim 15, wherein the first and second arms are each sized to extend between the first and second sidewalls.
